(19) United States
(12) Patent Application Publication
(10) Pub. No.: US 2017/0175867 A1
(43) Pub. Date: Jun. 22, 2017

(54) HYDRO-MECHANICAL TRANSMISSION ASSEMBLY FOR A MACHINE

(71) Applicant: Caterpillar Inc., Peoria, IL (US)

(72) Inventors: Michael Gross, Lacon, MN (US); Randall T Anderson, Peoria, IL (US); Rustin G Metzger, Congerville, IL (US); Matthew T Bober, Metamora, IL (US); Amogh A Deo, Peoria, IL (US); Guillaume Raffin, Moucherotte (FR); Robert A Jackson, Edwards, IL (US)

(73) Assignee: Caterpillar Inc., Peoria, IL (US)

(21) Appl. No.: 14/972,227

(22) Filed: Dec. 17, 2015

(51) Int. Cl. F16H 47/04; F16H 3/091; F16H 47/02; F16H 61/42; F16H 59/14; F16H 3/66; F16H 37/04

(52) U.S. Cl. CPC F16H 47/04; F16H 3/66; F16H 3/091; F16H 37/042; F16H 61/42; F16H 59/14; F16H 47/02; F16H 2200/2097; F16H 2200/201; F16H 2200/2041; F16H 2059/147

(57) ABSTRACT

A hydro-mechanical transmission assembly includes a hydrostatic pump-motor assembly having a variable displacement hydrostatic pump. The pump has a primary input shaft configured to be operatively driven by a prime mover. The hydrostatic pump-motor assembly also includes a hydraulic motor fluidly coupled to and operatively driven by the hydrostatic pump. The motor has a primary output shaft that is bi-directionally rotatable with change in displacement of the pump. The primary output shaft is coupled to a secondary input shaft of a multi-speed transmission, wherein the multi-speed transmission includes one of: a counter-shaft transmission system, a multi-stage planetary gear set, and a power-shift transmission system that includes a combination of the counter-shaft transmission system and the multi-stage planetary gear set. This way, a secondary output shaft of the multi-speed transmission is configured to operate with discrete speed ratios in relation to the primary output shaft of the hydraulic motor.

### TECHNICAL FIELD

The present disclosure relates to a drive train for a machine. More particularly, the present disclosure relates to a hydro-mechanical transmission assembly that can be used in a final drive system for selectively driving one or more loads of the machine for e.g., a pair of ground engaging members of the machine.

### BACKGROUND

Earth moving machines have long been known to employ drive systems for transmitting power from a prime mover into selectively driving one or more loads of the machine for e.g., one or more ground engaging members present on the machine. In some cases, these drive systems may include components that either constitute or form part of a hydro-mechanical transmission.

For reference, PCT publication WO 2013/074430 discloses a hydro-mechanical continuously variable transmission for producing high torque output. One transmission includes an engine drive shaft driven by an engine and a planetary gear unit driven by power from the engine and to provide power to drive a transmission output shaft. The transmission also includes a hydrostatic drive unit driven by power from the engine and to drive a primary hydrostatic drive shaft. The transmission includes an engine clutch to be driven by the engine and to drive an input sun gear of the planetary gear unit while engaged. The transmission includes a secondary hydrostatic drive shaft driven by the primary hydrostatic drive shaft and to drive a ring gear of the planetary gear unit. The transmission includes a hydrostatic output clutch driven by the secondary hydrostatic drive shaft and to provide power to drive an output sun gear of the planetary gear unit while engaged.

### SUMMARY OF THE DISCLOSURE

In an aspect of the present disclosure, a hydro-mechanical transmission assembly includes a variable displacement hydrostatic pump-motor assembly having a variable displacement hydrostatic pump. The hydrostatic pump has a primary input shaft configured to be operatively driven by a prime mover. The hydrostatic pump-motor assembly also includes a hydraulic motor fluidly coupled to the hydrostatic pump and operatively driven by the hydrostatic pump. The hydraulic motor has a primary output shaft that is bi-directionally rotatable with change in displacement of the hydrostatic pump. The primary output shaft is coupled to a secondary input shaft of one of: a counter-shaft transmission system, a multi-stage planetary gear set, and a power-shift transmission system that includes a combination of the counter-shaft transmission system and the multi-stage planetary gear set such that a secondary output shaft of one of the counter-shaft transmission system, the multi-stage planetary gear set, and the power-shift transmission system is configured to operate with discrete speed ratios in relation to the primary output shaft of the hydraulic motor.

In another aspect of the present disclosure, a drive train for a machine includes a hydro-mechanical transmission assembly and a differential assembly. The hydro-mechanical transmission assembly includes a variable displacement hydrostatic pump-motor assembly having a variable displacement hydrostatic pump. The hydrostatic pump has a primary input shaft configured to be operatively driven by a prime mover. The hydrostatic pump-motor assembly also includes a hydraulic motor fluidly coupled to the hydrostatic pump and operatively driven by the hydrostatic pump. The hydraulic motor has a primary output shaft that is bi-directionally rotatable with change in displacement of the hydrostatic pump. The primary output shaft is coupled to a secondary input shaft of one of: a counter-shaft transmission system, a multi-stage planetary gear set, and a power-shift transmission system that is a combination of the counter-shaft transmission system and the multi-stage planetary gear set such that a secondary output shaft of one of the counter-shaft transmission system, the multi-stage planetary gear set, and the power-shift transmission system is configured to operate with discrete speed ratios in relation to the primary output shaft of the hydraulic motor. The differential assembly is coupled to the secondary output shaft of one of: the counter-shaft transmission system, the multi-stage planetary gear set, and the power-shift transmission system such that the differential assembly is configured to operatively distribute output power from the secondary output shaft into driving one or more loads of the machine.

In yet another aspect of the present disclosure, embodiments disclosed herein have also been directed to a machine having a prime mover, and drive shaft rotatably coupled to the prime mover. The machine employs a drive train, consistent with embodiments of the present disclosure to transmit power from the drive shaft into driving one or more loads of the machine, for e.g., a pair of ground engaging members present on the machine.

Other features and aspects of this disclosure will be apparent from the following description and the accompanying drawings.

### BRIEF DESCRIPTION OF THE DRAWINGS

FIG. 1 is a side view of an exemplary machine, in which embodiments of the present disclosure can be implemented;

FIG. 2 is a diagrammatic illustration of a drive train that can be employed by the exemplary machine of FIG. 1 in accordance with embodiments of the present disclosure;

FIG. 3 is a schematic illustration of a hydro-mechanical transmission that can be employed by the drive train of FIG. 2, in accordance with an embodiment of the present disclosure; and

FIG. 4 is a schematic illustration of a hydro-mechanical transmission that can be employed by the drive train of FIG. 2, in accordance with another embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

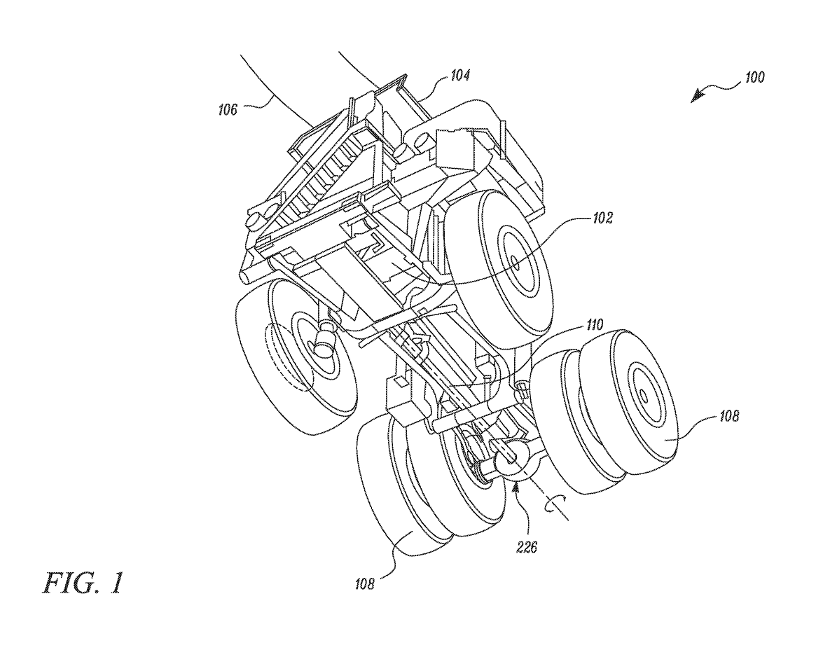

FIG. 1 illustrates an exemplary machine 100 that is embodied in the form of a wheeled vehicle, for e.g., a mining truck (as shown). The machine 100 may be used in a variety of applications including mining, quarrying, road construction, construction site preparation, etc. For example, the mining truck of the present disclosure may be employed for hauling earth materials such as soil, debris, or other naturally occurring deposits from a worksite. Although a mining truck is depicted in FIG. 1, other types of mobile machines such as, but not limited to, track-type tractors, motor graders, large wheel loaders, off-highway trucks, articulated trucks, on-highway trucks, or the like may be employed in lieu of the mining truck.

Referring to FIG. 1, the machine 100 includes a prime mover 102 for e.g., an engine. The engine disclosed herein can power the machine 100 by combustion of natural resources, such as gasoline, liquid natural gas, or other petroleum products. As such, the engine can be embodied as a petrol engine, a diesel engine, a dual-fuel engine or any other kind of engine utilizing combustion of fuel for generation of power.

It may be noted that although the prime mover 102 is disclosed as an engine, an electric motor could be used in lieu of the engine. Moreover, the electric motor may be a stand-alone electric motor, or an electric motor that can be used in conjunction with the engine. Therefore, the electric motor may be embodied in the form of any system that uses electric power for propulsion.

Further, the electric motor may, additionally or optionally, be powered with the help of a pantograph 104 and an overhead catenary 106 (shown in FIG. 1) that is provided for supplying current to the electric motor. Furthermore, as shown in the illustrated embodiment of FIG. 1, the machine 100 may also include an Electronic Control module (ECM) (not shown) that is configured to regulate an amount of power supplied from the overhead catenary 106 to the electric motor.

The machine 100 further includes multiple ground engaging members for e.g., wheels 108 that are selectively coupled to the prime mover 102 using various components explanation to which will be made later herein. The ground engaging members are configured to receive driving power from the prime mover 102. As shown in FIG. 1, the machine 100 further includes a driven shaft 110 that is configured to transmit driving power from the prime mover 102 to the wheels 108. Although wheels 108 have been disclosed herein, other suitable types of ground engaging members known in the art can be used in lieu of the wheels. As such, in alternative embodiments of the present disclosure, the machine 100 can optionally be embodied in the form of a tracked vehicle i.e., a vehicle employing tracks or crawlers.

Further, the machine 100 may be a manually-operated machine, an autonomous machine, or a machine that is operable in both manual and autonomous mode. Therefore, notwithstanding any particular type or configuration of machine disclosed in this document, it will be appreciated that systems disclosed herein can be similarly applied to other types of machines, mobile or stationary, known to one skilled in the art without deviating from the spirit of the present disclosure.

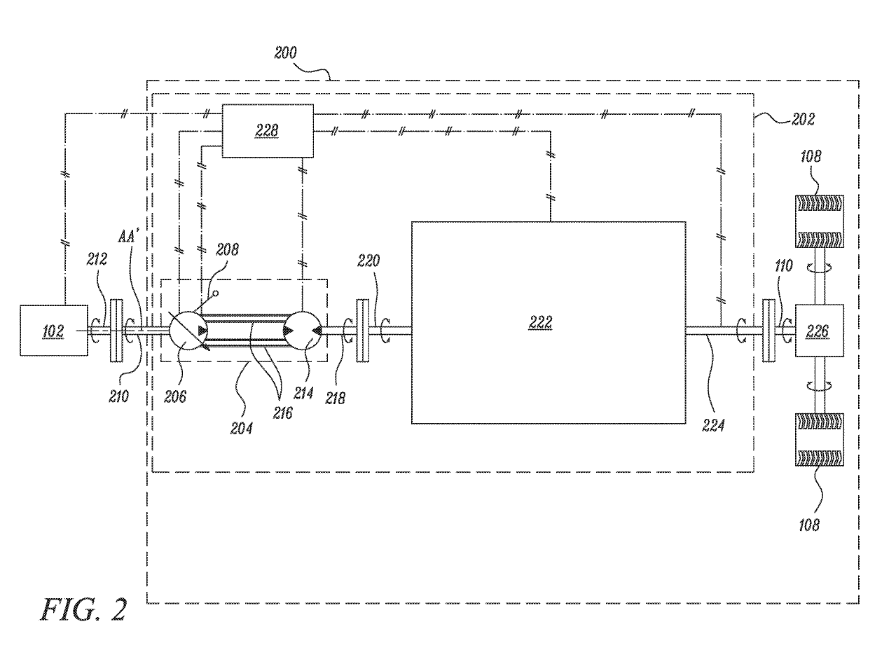

FIG. 2 provides a diagrammatic illustration of a drive train 200 that can be employed by the machine 100, in accordance with embodiments of the present disclosure. The drive train 200 includes a hydro-mechanical transmission assembly 202. The hydro-mechanical transmission assembly 202 includes a variable displacement hydrostatic pump-motor assembly 204 having a variable displacement hydrostatic pump 206. In an embodiment as shown in FIG. 2, the variable displacement hydrostatic pump 206 may be an axial flow piston pump having a movable swash plate 208 disposed therein. However, it may be noted that a type of variable displacement pump used is non-limiting of this disclosure. Numerous other types of variable displacement pumps such as, but not limited to, a variable displacement rotary vane pump may be used in lieu of the axial flow piston pump disclosed herein without deviating from the spirit of the present disclosure.

The hydrostatic pump 206 has a primary input shaft 210 configured to be operatively driven by the prime mover 102. The primary input shaft 210 may be rigidly coupled to a drive shaft 212 of the prime mover 102 as shown in FIG. 2, or may alternatively be disposed in a gearing arrangement with the drive shaft 212 of the prime mover 102.

The hydrostatic pump-motor assembly 204 also includes a hydraulic motor 214 fluidly coupled to the hydrostatic pump 206 and operatively driven by the hydrostatic pump 206. In one embodiment of this disclosure, the hydraulic motor 214 could be a fixed displacement hydraulic motor 214. In another embodiment, the hydraulic motor 214 could be embodied in the form of a variable displacement hydraulic motor 214.

The hydraulic motor 214 may be fluidly coupled to the hydrostatic pump 206 with the help of hoses 216 (as shown), tubes, or passageways formed in a housing (not shown) of the hydrostatic pump-motor assembly 204. As such, a manner of disposing the hydraulic motor 214 in fluid communication with the hydrostatic pump 206 is exemplary in nature and hence, non-limiting of this disclosure. A person having ordinary skill in the art can contemplate using any means of disposing the hydraulic motor 214 in fluid communication with the hydrostatic pump 206.

The hydraulic motor 214 has a primary output shaft 218 that is bi-directionally rotatable with change in displacement of the hydrostatic pump 206. As known to one skilled in the art, a change in displacement of the hydrostatic pump 206 can be brought about by, for e.g., changing a position of the swash plate 208 in the axial flow pump 206 relative to an axis of rotation AA′ of the primary input shaft 210. However, it may be noted that in other embodiments, displacement of the hydrostatic pump 206 can be varied by numerous other means depending on a type of variable displacement pump 206 used in the hydrostatic pump-motor assembly 204.

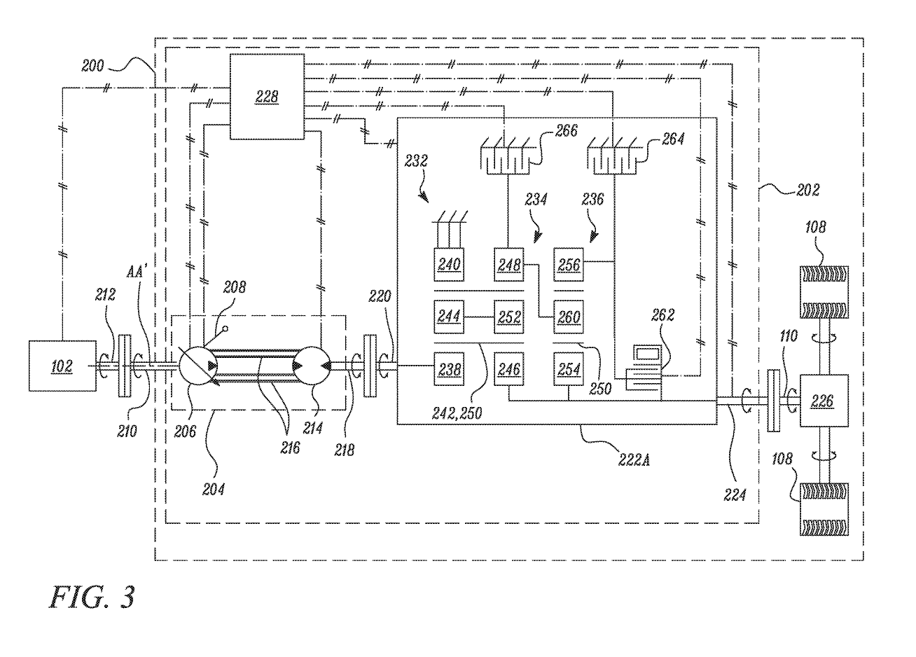

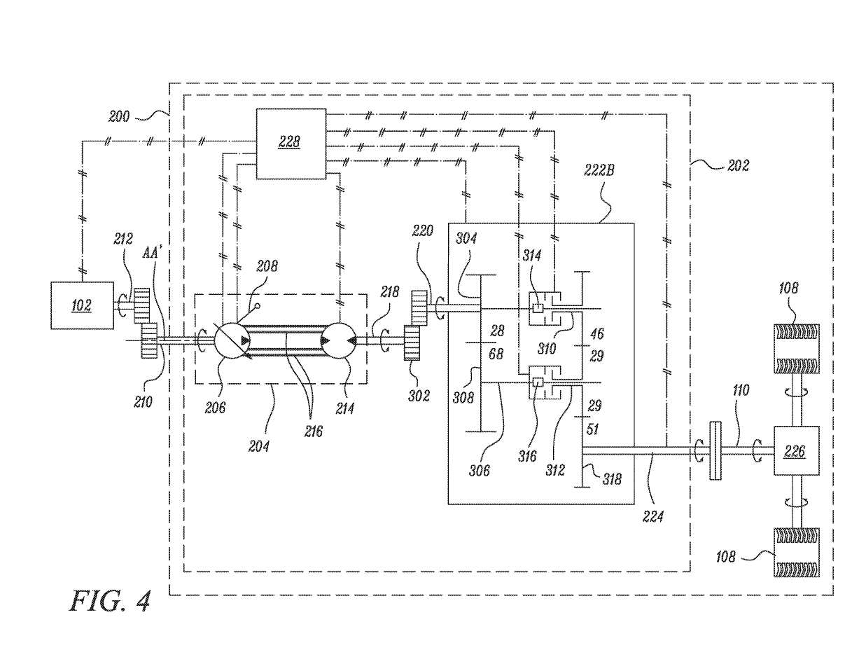

The primary output shaft 218 of the hydraulic motor 214 is coupled to a secondary input shaft 220 of a multi-speed transmission 222. In one embodiment as shown in FIG. 3, the multi-speed transmission 222 may be embodied in the form of a multi-stage planetary gear set. In another embodiment as shown in FIG. 4, the multi-speed transmission 222 may be embodied in the form of a counter-shaft transmission system 222B.

Referring again to FIG. 2, a secondary output shaft 224 of the multi-speed transmission 222, for e.g. the counter-shaft transmission system 222B or the multi-stage planetary gear set, is configured to operate with discrete speed ratios in relation to the primary output shaft 218 of the hydraulic motor 214 and the secondary input shaft 220 of the multi-speed transmission 222. Moreover, as shown in FIG. 2, the drive train 200 further includes a differential assembly 226 that is coupled to the secondary output shaft 224 of the multi-speed transmission 222 such that the differential assembly 226 is configured to operatively distribute output power from the secondary output shaft 224 into driving one or more loads of the machine 100. In an embodiment as shown in FIGS. 1 and 2, the secondary output shaft 224 is shown to be flexibly coupled to the driven shaft 110 associated with the differential assembly 226 such that the differential assembly 226 is configured to operatively distribute output power from the secondary output shaft 224 into driving the ground engaging members i.e., wheels 108 of the machine 100.

In various embodiments of the present disclosure, the hydro-mechanical transmission assembly 202 also includes a controller 228 as shown in FIG. 2. The controller 228 is communicably coupled to the hydrostatic pump 206 and the hydraulic motor 214. The controller 228 is configured to control a displacement in the hydrostatic pump 206 based on operating conditions of at least one of: the prime mover 102 coupled to the hydrostatic pump 206; and the multi-speed transmission 222 for e.g., the multi-stage planetary gear set 222A of FIG. 3 or the counter-shaft transmission system 222B of FIG. 4. In one embodiment, the controller 228 may be configured to control an amount of displacement in the hydrostatic pump 206 based on an amount of load coupled to the secondary output shaft 224 of either the multi-stage planetary gear set 222A as shown in FIG. 3 or the counter-shaft transmission system 222B as shown in FIG. 4. For example, the controller 228 could modulate a position of the swash plate 208 in the axial piston pump 206 relative to the axis AA′ based on the amount of load on the secondary output shaft 224.

Although it has been disclosed herein by way of example that operating conditions may include an amount of load on the secondary output shaft 224, it should be noted that “operating conditions” disclosed herein is not limited to the load on the secondary output shaft 224 of the multi-speed transmission system 222 i.e., the multi-stage planetary gear set 222A of FIG. 3 or the counter-shaft transmission system 222B of FIG. 4. Rather a scope of the terms “operating conditions” could extend to include any type of operating condition or aspect pertaining to the prime mover 102 and/or the multi-speed transmission 222 typically known to persons skilled in the art. For example, the controller 228 may be coupled to sensors that are operable to provide signals indicative of parameters related to the prime mover 102, the transmission assembly 202, any powered components, and/or any other components of machine 100. In an example, the sensors could provide signals indicative of operating parameters related to the transmission assembly 202 including, but not limited to, fluid pressure, fluid temperature, displacement, speed, and/or any other suitable operating parameters. In another example, these sensors may also be operable to provide signals indicative of operating parameters related to the prime mover 102, including, but not limited to, engine speed. Therefore, notwithstanding anything contained in this document, it may be noted that the controller 228 may be additionally associated with suitable system hardware such as, but not limited to, sensors, solenoids, actuators, and the like for accomplishing a control in the displacement in the hydrostatic pump 206 and performing other functions consistent with the present disclosure.

In another embodiment of this disclosure, the controller 228 could also be configured to determine current torque loads and actual torque demands on the prime mover 102; and the hydrostatic pump 206 and motor 214 of the hydrostatic pump-motor assembly 204. In this embodiment, the controller 228 may change an amount of displacement associated with the hydrostatic pump 206 on the basis of the determined current torque loads and actual torque demands on one or more of: the prime mover 102, the hydrostatic pump 206, and the hydraulic motor 214. Explanation pertaining to such determination of current torque loads and actual torque demands for changing the amount of displacement in a hydrostatic pump is well known in the art. An example of such functionality is disclosed in U.S. Pat. No. 8,515,637 (hereinafter ‘the '637 patent’) and the functionality disclosed in the '637 patent may be incorporated herein for the purposes of the present disclosure.

FIG. 3 illustrates the hydro-mechanical transmission assembly 202 in accordance with an embodiment of this disclosure. As disclosed earlier herein, in one embodiment, the multi-stage planetary gear set 222A of FIG. 3 embodies the multi-speed transmission 222 of FIG. 2. Further, as shown in the embodiment of FIG. 3, the multi-stage planetary gear set 222A is embodied as a 3-stage planetary gear set. For the sake of convenience, the multi-stage planetary gear set 222A will hereinafter be referred to as ‘the 3-stage planetary gear set 222A’ and designated with alpha-numeral ‘222A’.

Although the present disclosure is explained in conjunction with the 3-stage planetary gear set 222A, it should be noted that systems disclosed herein can be equally applied to other types of planetary gear sets having fewer or more stages without limiting the scope of the appended claims and/or deviating from the spirit of the present disclosure.

Moreover, it should be noted that for purposes of simplicity and clarity in understanding the present disclosure, only one half i.e., an upper half of the 3-stage planetary gear set 222A is shown in FIG. 3. As such, the 3-stage planetary gear set also includes another portion i.e., the lower half—mirror image of the upper half, disposed below the upper half of the 3-stage planetary gear-set currently shown in FIG. 3.

The 3-stage planetary gear set 222A includes a first gear set 232, a second gear set 234, and a third gear set 236. Each of the first, second, and third gear sets 232, 234, and 236 include a sun gear, a ring gear, and a planet carrier respectively. As shown, the first gear set 232 includes the sun gear 238, the ring gear 240, and the planet carrier 242. The second gear set 234 includes the sun gear 246, the ring gear 248, and the planet carrier 250. The third gear set 236 includes the sun gear 254, the ring gear 256, and the planet carrier 258. The planet carrier 242 of the first gear set 232 includes a plurality of planet gears—only one planet gear 252 visible in the upper half of the 3-stage planetary gear set 222A. The planet gear 252 is disposed in mesh between the sun gear 238 and the ring gear 240 of the first gear set 232. Similarly, the planet carrier 250 of the second gear set 234 includes a planet gear 252 disposed in mesh between the sun gear 246 and the ring gear 248 of the second gear set 234 while the planet carrier 258 of the third gear set 236 includes a planet gear 260 disposed in mesh between the sun gear 254 and the ring gear 256 of the third gear set 236.

Moreover, the sun gear 238 of the first gear set 232 is rigidly coupled with the secondary input shaft 220 while the sun gear 254 of the third gear set 236 is rigidly coupled with the secondary output shaft 224. Further, the planet carriers 242, 250 of the first and second gear sets 232, 234 are being mutually coupled so as to rotate in unison. In an alternative embodiment, it can be beneficially contemplated to use a common planet carrier (not shown) for the first and second gear sets 232, 234. Such common planet carrier can be further configured to have planet gears that extend between the first and second gears sets 232, 234 so as to form common planet gears for the first and second gear sets 232, 234 respectively.

Furthermore, as shown in the illustrated embodiment of FIG. 3, the ring gear 240 of the first gear set 232 is disposed stationary. The ring gear 248 from the second gear set 234 and the planet carrier 258 from the third gear set 236 are mutually coupled so as to rotate in unison. The primary output shaft 218 of the hydraulic motor 214 is disposed in mesh with the secondary input shaft 220 so as to provide input power and rotatably drive the sun gear 238 of the first gear set 232. With such configuration of the hydrostatic pump-motor assembly 204 and the 3-stage planetary gear set 222A, the primary output shaft 218 of the hydraulic motor 214 and the secondary input shaft 220 are bi-directionally rotatable with change in displacement of the hydrostatic pump 206 for rotating the secondary output shaft 224 with discrete speed ratios (hereinafter also referred to as ‘gear ratios’) in relation to the primary output shaft 218 of the hydraulic motor 214 and/or the secondary input shaft 220 of the 3-stage planetary gear set 222A.

In an exemplary embodiment as shown in FIG. 3, each of the first and second gear set 232, 234 may be configured to exhibit a gear ratio or speed ratio for e.g., 2.142 while the third gear set 236 may be configured to exhibit a gear ratio of for e.g., 1.765.

In a first mode of operation, a first overall gear ratio or speed ratio may be obtained from the 3-stage planetary gear set 222A by actuating a first clutch 262. As shown, the first clutch 262 is communicably coupled to the controller 228 and may be operable to rotationally lock the ring gear 256 from the third gear set 236 with the sun gears 238, 246 from the first and second gear set 232, 234. The first clutch 262 may therefore be operable to output an overall first gear ratio or overall first speed ratio of 3.144 between the secondary input shaft 220 and the secondary output shaft 224. The terms ‘speed ratio’ disclosed herein can be regarded as a ratio between an input speed and an output speed of the multi-stage planetary gear set 222A, the input and output speeds being measured at the secondary input shaft 220 and the secondary output shaft 224 respectively.

In a second mode of operation, a second overall gear ratio or speed ratio may be obtained from the 3-stage planetary gear set 222A by actuating a second clutch 264. As shown, the second clutch 264 is communicably coupled to the controller 228 and may be operable to rotationally lock the ring gear 256 from the third gear set 236 with a stationary housing (not shown) of the 3-stage planetary gear set 222A. Upon actuation of the second clutch 264, a second overall second gear ratio or an overall second speed ratio of for e.g., 1.775 may be obtained between the secondary input shaft 220 and the secondary output shaft 224.

In a third mode of operation, a third overall gear ratio or speed ratio may be obtained from the 3-stage planetary gear set 222A by actuating a third clutch 266. As shown, the third clutch 266 is communicably coupled to the controller 228 and may be operable to rotationally lock the ring gear 248 from the second gear set 234 with the stationary housing of the 3-stage planetary gear set 222A. The third clutch 266 may therefore be operable to output an overall third gear ratio or an overall third speed ratio of for e.g., 1.000 between the secondary input shaft 220 and the secondary output shaft 224 of the 3-stage planetary gear set 222A.

With implementation of the drive train 200 shown in FIG. 3, various discrete ranges of overall gear ratios may be obtained. Further, these discrete ranges of overall gear ratios may lie close to one another. Furthermore, in an embodiment of this disclosure, if the multi-stage planetary gear set 222A is configured with high individual gear ratios from the first, second, and third gear sets 232, 234, and 236; it is envisioned that these discrete ranges of overall gear ratios may also be high in value (greater than or equal to that for direct drive where the overall gear ratio or speed ratio is 1:1) and such discrete ranges of high overall gear ratios from the 3-stage planetary gear set 222A may be beneficially applicable in powering loads typically encountered in high torque applications for e.g., in earth moving machines such as, but not limited to, track type tractors; in construction equipment such as, but not limited to, motor graders; and the like.

Moreover, with bi-directional rotation capabilities i.e., clockwise and counter-clockwise rotation of the primary output shaft 218 vis-à-vis the hydrostatic variable pump-motor assembly 204, such discrete ranges of overall gear ratios from the 3-stage planetary gear set 222A can be realized for both—clockwise rotation and counter-clockwise rotation of the secondary input shaft 220 and therefore, in both—forward direction and reverse direction of travel of the machine 100. Although the foregoing disclosure discloses features and advantages of discrete ranges of overall gear ratios lying close to one another and the discrete ranges of overall gear ratios being high in value for the hydro-mechanical transmission assembly 202 of FIG. 3, such features and advantages disclosed herein can be regarded as being applicable in the case of the hydro-mechanical transmission assembly 202 of FIG. 4 appended herein.

FIG. 4 illustrates the hydro-mechanical transmission assembly 202 in accordance with another embodiment of this disclosure. As disclosed earlier herein, in another embodiment, the counter-shaft transmission system 222B of FIG. 4 embodies the multi-speed transmission 222 of FIG. 2. For the sake of convenience, the multi-speed transmission 222 will hereinafter be referred to as ‘counter-shaft transmission system’ and designated with alpha-numeral ‘222B’.

Referring to FIG. 4, the secondary input shaft 220 of the counter-shaft transmission system 222B could be directly coupled to the primary output shaft 218 of the hydraulic motor 214. In an alternative embodiment as shown in FIG. 4, the secondary input shaft 220 of the counter-shaft transmission system 222B could be disposed in a gearing arrangement with the primary output shaft 218 of the hydraulic motor 214. As shown, an input gear 304 could be rigidly disposed on the secondary input shaft 220. This input gear 304 is further disposed in mesh with an output gear 302 rigidly coupled to the primary output shaft 218 of the hydraulic motor 214. The input gear 304 and the output gear 302 disclosed herein may be embodied in one of: a spur gear configuration, a helical gear configuration or double helical gear configuration as known to one skilled in the art. However, it may be noted that any type of coupling arrangement known in the art may be used to couple the primary output shaft 218 of the hydraulic motor 214 with the secondary input shaft 220 of the counter-shaft transmission system 222B without deviating from the spirit of the present disclosure.

The counter-shaft transmission system 222B also includes a layshaft 306 having a primary gear 308 disposed in a fixed-step gear reduction with the input gear 304. The counter-shaft transmission system 222B further includes at least two secondary gears. As such, only two secondary gears 310, 312 are shown in the illustrated embodiment of FIG. 4. The two secondary gears 310, 312 disclosed herein may be spur gears, helical gears or double helical gears as known to one skilled in the art. The first secondary gear 310 is rotatably mounted on and selectively engaged with the secondary input shaft 220 via a first clutch 314, the first clutch 314 being electronically controllable by the controller 228. The second secondary gear 312 is rotatably mounted on and selectively engaged with the layshaft 306 via a second clutch 316, the second clutch 316 being electronically controllable by the controller 228. The second secondary gear 312 is also disposed in mesh with the first secondary gear 310 and an output gear 318 rigidly mounted on the secondary output shaft 224 of the counter-shaft transmission such that upon rotation of the secondary input shaft 220 and the layshaft 306 and with independent actuation of one of the first and second clutches 314, 316, the secondary output shaft 224 can bi-directionally rotate with discrete speed ratios in relation to the secondary input shaft 220 of the counter-shaft transmission system 222B.

In a first mode of operation of the counter-shaft transmission system 222B, an actuation of the first clutch 314 can cause the first secondary gear 310 to be rotationally locked with the rotating secondary input shaft 220. The power from the secondary input shaft 220 is therefore, transmitted to the second secondary gear 312 via the first secondary gear 310. The second secondary gear 312 then transfers this power into the output gear 318 rigidly disposed on the secondary output shaft 224 of the counter-shaft transmission thus causing the secondary output shaft 224 to rotate at a first discrete gear ratio or speed ratio with respect to the secondary input shaft 220.

In a second mode of operation of the counter-shaft transmission system 222B, an actuation of the second clutch 316 can cause the second secondary gear 312 to be rotationally locked with the rotating layshaft 306. Power from the secondary input shaft 220 is therefore, transmitted from the input gear 304 on the secondary input shaft 220 into the intermeshed primary gear 308. The second secondary gear 312, that is rotationally locked with the rotating layshaft 306, then transfers this power to the output gear 318 rigidly disposed on the secondary output shaft 224 of the counter-shaft transmission thus causing the secondary output shaft 224 to rotate at a second discrete gear ratio or speed ratio with respect to the secondary input shaft 220.

In an example as shown in FIG. 4, a number of teeth on each of the gears in the counter-shaft transmission system 222B are illustrated adjacent to the respective gears for. e.g., 68 teeth on gear 308, 29 teeth on gear 312, etc. With these values, a higher gear ratio or speed ratio can be obtained with actuation of the second clutch 316 as compared to the first clutch 314. More specifically, with the exemplary values shown in FIG. 4, it is envisioned that actuation of the first clutch 314 may cause an overall first gear ratio or first speed ratio of 1.1087 while actuation of the second clutch 316 may cause an overall second gear ratio or speed ratio of 4.2709 to be implemented in the counter-shaft transmission system 222B. As disclosed earlier herein, it may be noted that the terms ‘overall speed ratio’ can be regarded as the ratio between the input speed and the output speed, the input and output speeds being measured at the secondary input shaft 220 and the secondary output shaft 224 respectively.

Moreover, with use of the hydrostatic pump-motor assembly 204 in conjunction with the counter-shaft transmission system 222B of FIG. 4, the primary output shaft 218 can be bi-directionally rotatable with a variation in displacement of the hydrostatic pump 206. Therefore, the overall gear ratios or speed ratios of 1.1087 and 4.2709 implemented using the first clutch 314 and the second clutch 316 can be realized when the primary output shaft 218 and the secondary input shaft 220 are rotating in either of—a clockwise and a counter-clockwise direction. Moreover, with implementation of the hydrostatic pump-motor assembly 204 in the counter-shaft transmission system 222B, a direction of travel of the machine 100 can be seamlessly shifted from a forward direction to a reverse direction and vice-versa.

It may be noted that the feature of seamless change in the direction of travel of the machine 100 is also applicable in the drive train 200 of FIG. 3 as well. Therefore, it will be apparent to one skilled in the art that various features and advantages disclosed herein for one type of drive train 200 for e.g., drive train 200 using the multi-stage planetary gear set 222A of FIG. 3, can also be realized in the other type of drive train 200 disclosed herein i.e., drive train 200 using the counter-shaft transmission system 222B of FIG. 4 and vice-versa without limiting the scope of the present disclosure. It is hereby contemplated that with use of the hydrostatic pump-motor assembly 204 in conjunction with the either of the counter-shaft transmission system 222B and the multi-stage planetary gear set 222A, reverse gearing arrangements and idler gearing arrangements typically encountered in previously known transmission systems may be omitted as the direction of rotation of the secondary output shaft 224 can be smoothly and easily changed by merely changing an amount of displacement in the hydrostatic pump 206 disclosed herein.

It may be noted that although the present disclosure is explained in conjunction with the multi-stage planetary gear set 222A, and the counter-shaft transmission system 222B, it is also contemplated that in other embodiments of the present disclosure, the variable displacement hydrostatic pump-motor assembly 204 may be coupled to a power-shift transmission system (not shown) that is a combination of a multi-stage planetary gear set for e.g., the multi-stage planetary gear set 222A and a counter-shaft transmission system for e.g., the counter-shaft transmission system 222B. It may be noted that the power-shift transmission system disclosed herein could include a combination of any type of multi-stage planetary gear set and a counter-shaft transmission system therein. For the purposes of the present disclosure, such a power-shift transmission system can be regarded as being figuratively depicted by the multi-speed transmission 222 of FIG. 2 in this disclosure.

Moreover, it is well known to persons skilled in the art that such power-shift transmission systems have been typically used in some of the heavy machinery for e.g., a motor grader. Therefore, embodiments of the present disclosure, when implemented with such power-shift transmission systems can beneficially help produce robust hydro-mechanical transmission assemblies for working in high torque applications.

Various embodiments disclosed herein are to be taken in the illustrative and explanatory sense, and should in no way be construed as limiting of the present disclosure. All joinder references (e.g., attached, affixed, coupled, engaged, connected, locked, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for use and implementation in producing robust, compact, and cost-effective drive trains. Moreover, embodiments of the present disclosure also have applicability in reducing an overall number of components while also allowing an increased power density of components used in the drive train.

As embodiments disclosed herein allow manufacturers of drive trains to reduce an overall number of components for e.g., a reverse gear arrangement, an idler gear arrangement, etc., costs typically incurred with previously known drive train systems can be offset. Furthermore, embodiments of the present disclosure also allow operators of the machine 100 to smoothly transition the machine 100 from the forward direction of travel to the reverse direction of travel and vice-versa without the need for additional clutches. With omission of such clutches possible, manufactures of drive trains can further reduce costs associated with producing drive trains. Therefore, embodiments of the present disclosure have applicability in helping manufacturers of drive trains to reduce costs associated with an overall number of components while also rendering the drive train to be compact and robust in design.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A hydro-mechanical transmission assembly including:
a variable displacement hydrostatic pump-motor assembly including:
a variable displacement hydrostatic pump having a primary input shaft configured to be operatively driven by a prime mover; and
a hydraulic motor fluidly coupled to the hydrostatic pump and configured to be operatively driven by the hydrostatic pump, the hydraulic motor having a primary output shaft bi-directionally rotatable with change in displacement of the hydrostatic pump, the primary output shaft coupled to a secondary input shaft of a multi-speed transmission.

2. The hydro-mechanical transmission assembly of claim 1, wherein the multi-speed transmission includes one of:
a counter-shaft transmission system;
a multi-stage planetary gear set; and
a power-shift transmission system, wherein the power-shift transmission system is a combination of the counter-shaft transmission system and the multi-stage planetary gear set; wherein a secondary output shaft of one of the counter-shaft transmission system, the multi-stage planetary gear set, and the power-shift transmission is configured to operate with discrete speed ratios in relation to the primary output shaft of the hydraulic motor.

3. The hydro-mechanical transmission assembly of claim 2, wherein the multi-stage planetary gear set is a 3-stage planetary gear train including:
a first gear set, a second gear set, and a third gear set, each of the first, second, and third gear sets having a sun gear, a ring gear, and a planet carrier including a plurality of planet gears disposed in mesh between the sun gear and the ring gear of a respective gear set, wherein:
the sun gear of the first gear set carries the secondary input shaft;
the sun gear of the third gear set carries the secondary output shaft;
the ring gear of the first gear set is disposed stationary;
the planet carriers of the first and second gear sets are being mutually coupled so as to rotate in unison; and
the ring gear from the second gear set and the planet carrier from the third gear set are mutually coupled so as to rotate in unison; wherein the primary output shaft of the hydraulic motor is disposed in mesh with the secondary input shaft so as to provide input power and rotatably drive the sun gear of the first gear set, wherein the primary output shaft of the motor is bi-directionally rotatable with change in displacement of the hydrostatic pump for rotating the secondary output shaft with discrete speed ratios in relation to the primary output shaft of the hydraulic motor.

4. The hydro-mechanical transmission assembly of claim 2, wherein the counter-shaft transmission system includes:
an input gear rigidly disposed on the secondary input shaft of the counter-shaft transmission system, the input gear configured to be operatively driven by an output gear rigidly disposed on the primary output shaft of the hydraulic motor;
a layshaft having a primary gear disposed in a fixed-step gear reduction with the input gear; and
at least two secondary gears, wherein:
a first secondary gear is rotatably mounted on and selectively engaged with the secondary input shaft via a first clutch; and
a second secondary gear is rotatably mounted on and selectively engaged with the layshaft via a second clutch, the second secondary gear being disposed in mesh with the first secondary gear and an output gear rigidly mounted on the secondary output shaft of the counter-shaft transmission such that the secondary output shaft is configured to bi-directionally rotate with discrete speed ratios in relation to the secondary input shaft of the counter-shaft transmission system upon independent actuation of one of the first and second clutches.

5. The hydro-mechanical transmission assembly of claim 2 further including a controller communicably coupled to the hydrostatic pump and the motor, the controller being configured to control a displacement in the hydrostatic pump based on operating conditions of at least one of:
the prime mover coupled to the hydrostatic pump; and
the multi-speed transmission, wherein the multi-speed transmission includes one of:
the multi-stage planetary gear set;
the counter-shaft transmission system; and
the power-shift transmission.

6. The hydro-mechanical transmission assembly of claim 5, wherein the controller is configured to:
determine current torque load and actual torque demand on at least one of:
the prime mover coupled with the variable displacement hydrostatic pump; and
the hydrostatic pump and motor of the hydrostatic pump-motor assembly; and
change an amount of displacement associated with the hydrostatic pump on the basis of the determined current torque load and actual torque demand.

7. The hydro-mechanical transmission assembly of claim 1, wherein the motor is one of: a fixed displacement hydraulic motor and a variable displacement hydraulic motor.

8. The hydro-mechanical transmission assembly of claim 1, wherein the variable displacement hydrostatic pump is an axial-flow piston pump.

9. A drive train for a machine including:
a hydro-mechanical transmission assembly including:
a variable displacement hydrostatic pump-motor assembly including:
a variable displacement hydrostatic pump having a primary input shaft configured to be operatively driven by a prime mover; and
a hydraulic motor fluidly coupled to the hydrostatic pump and configured to be operatively driven by the hydrostatic pump, the hydraulic motor having a primary output shaft bi-directionally rotatable with change in displacement of the hydrostatic pump, the primary output shaft coupled to a secondary input shaft of a multi-speed transmission, wherein the multi-speed transmission includes one of:
a counter-shaft transmission system;
a multi-stage planetary gear set; and
a power-shift transmission system, wherein the power-shift transmission system is a combination of the counter-shaft transmission system and the multi-stage planetary gear set; wherein a secondary output shaft of one of the counter-shaft transmission system, the multi-stage planetary gear set, and the power-shift transmission system is configured to operate with discrete speed ratios in relation to the primary output shaft of the hydraulic motor; and
a differential assembly coupled to the secondary output shaft of one of: the counter-shaft transmission system, the multi-stage planetary gear set, and the power-shift transmission system; wherein the differential assembly is configured to operatively distribute output power from the secondary output shaft into driving one or more loads of the machine.

10. The drive train of claim 9, wherein the multi-stage planetary gear set is a 3-stage planetary gear train including:
a first gear set, a second gear set, and a third gear set, each of the first, second, and third gear sets having a sun gear, a ring gear, and a planet carrier including a plurality of planet gears disposed in mesh between the sun gear and the ring gear of a respective gear set, wherein:
the sun gear of the first gear set carries the secondary input shaft;
the sun gear of the third gear set carries the secondary output shaft;
the ring gear of the first gear set is disposed stationary;
the planet carriers of the first and second gear sets are being mutually coupled so as to rotate in unison; and
the ring gear from the second gear set and the planet carrier from the third gear set are mutually coupled so as to rotate in unison; wherein the primary output shaft of the hydraulic motor is disposed in mesh with the secondary input shaft so as to provide input power and rotatably drive the sun gear of the first gear set, wherein the primary output shaft of the motor is bi-directionally rotatable with change in displacement of the hydrostatic pump for rotating the secondary output shaft with discrete speed ratios in relation to the primary output shaft of the hydraulic motor.

11. The drive train of claim 9, wherein the counter-shaft transmission system includes:
an input gear rigidly disposed on the secondary input shaft of the counter-shaft transmission system, the input gear configured to be operatively driven by an output gear rigidly disposed on the primary output shaft of the hydraulic motor;
a layshaft having a primary gear disposed in a fixed-step gear reduction with the input gear; and
at least two secondary gears, wherein:
a first secondary gear is rotatably mounted on and selectively engaged with the secondary input shaft via a first clutch; and
a second secondary gear is rotatably mounted on and selectively engaged with the layshaft via a second clutch, the second secondary gear being disposed in mesh with the first secondary gear and an output gear rigidly mounted on the secondary output shaft of the counter-shaft transmission such that the secondary output shaft is configured to bi-directionally rotate with discrete speed ratios in relation to the secondary input shaft of the counter-shaft transmission system upon independent actuation of one of the first and second clutches.

12. The drive train of claim 9, wherein the hydro-mechanical transmission assembly further includes a controller communicably coupled to the hydrostatic pump and the motor, the controller being configured to control a displacement in the hydrostatic pump based on operating conditions of at least one of:
the prime mover coupled to the hydrostatic pump; and
the multi-speed transmission system, wherein the multi-stage transmission includes one of:
the multi-stage planetary gear set;
the counter-shaft transmission system; and
the power-shift transmission system.

13. The drive train of claim 12, wherein the controller is configured to:
determine current torque load and actual torque demand on at least one of:
the prime mover coupled with the variable displacement hydrostatic pump; and
the hydrostatic pump and motor of the hydrostatic pump-motor assembly; and
change an amount of displacement associated with the hydrostatic pump on the basis of the determined current torque load and actual torque demand.

14. The drive train of claim 9, wherein the hydraulic motor is one of: a fixed displacement hydraulic motor and a variable displacement hydraulic motor.

15. The drive train of claim 9, wherein the variable displacement hydrostatic pump is an axial-flow piston pump.

16. A machine including:
a prime mover;
a hydro-mechanical transmission assembly including:
a variable displacement hydrostatic pump-motor assembly including:
a variable displacement hydrostatic pump having a primary input shaft configured to be operatively driven by the prime mover; and
a hydraulic motor fluidly coupled to the hydrostatic pump and configured to be operatively driven by the hydrostatic pump, the hydraulic motor having a primary output shaft bi-directionally rotatable with change in displacement of the hydrostatic pump, the primary output shaft coupled to a secondary input shaft of a multi-speed transmission, wherein the multi-speed transmission includes one of:
a counter-shaft transmission system;
a multi-stage planetary gear set; and
a power-shift transmission system, wherein the power-shift transmission system is a combination of the counter-shaft transmission system and the multi-stage planetary gear set; wherein a secondary output shaft of one of the counter-shaft transmission system, the multi-stage planetary gear set, and the power-shift transmission system is configured to operate with discrete speed ratios in relation to the primary output shaft of the hydraulic motor; and
a differential assembly coupled to the secondary output shaft of one of: the counter-shaft transmission system, the multi-stage planetary gear set, and the power-shift transmission system; wherein the differential assembly is configured to operatively distribute output power from the secondary output shaft into driving one or more loads of the machine.

17. The machine of claim 16, wherein the multi-stage planetary gear set is a 3-stage planetary gear train including:
a first gear set, a second gear set, and a third gear set, each of the first, second, and third gear sets having a sun gear, a ring gear, and a planet carrier including a plurality of planet gears disposed in mesh between the sun gear and the ring gear of a respective gear set, wherein:
the sun gear of the first gear set carries the secondary input shaft;
the sun gear of the third gear set carries the secondary output shaft;
the ring gear of the first gear set is disposed stationary;
the planet carriers of the first and second gear sets are being mutually coupled so as to rotate in unison; and
the ring gear from the second gear set and the planet carrier from the third gear set are mutually coupled so as to rotate in unison; wherein the primary output shaft of the hydraulic motor is disposed in mesh with the secondary input shaft so as to provide input power and rotatably drive the sun gear of the first gear set, wherein the primary output shaft of the motor is bi-directionally rotatable with change in displacement of the hydrostatic pump for rotating the secondary output shaft with discrete speed ratios in relation to the primary output shaft of the hydraulic motor.

18. The machine of claim 16, wherein the counter-shaft transmission system includes:
an input gear rigidly disposed on the secondary input shaft of the counter-shaft transmission system, the input gear configured to be operatively driven by an output gear rigidly disposed on the primary output shaft of the hydraulic motor;
a layshaft having a primary gear disposed in a fixed-step gear reduction with the input gear; and
at least two secondary gears, wherein:
a first secondary gear is rotatably mounted on and selectively engaged with the secondary input shaft via a first clutch; and
a second secondary gear is rotatably mounted on and selectively engaged with the layshaft via a second clutch, the second secondary gear being disposed in mesh with the first secondary gear and an output gear rigidly mounted on the secondary output shaft of the counter-shaft transmission such that the secondary output shaft is configured to bi-directionally rotate with discrete speed ratios in relation to the secondary input shaft of the counter-shaft transmission system upon independent actuation of one of the first and second clutches.

19. The machine of claim 16 further including a controller communicably coupled to the hydrostatic pump and the motor, the controller being configured to control a displacement in the hydrostatic pump based on operating conditions of at least one of:
the prime mover coupled to the hydrostatic pump; and
the multi-speed transmission system, wherein the multi-stage transmission includes one of:
the multi-stage planetary gear set;
the counter-shaft transmission system; and
the power-shift transmission system.

20. The machine of claim 19, wherein the controller is configured to:
determine current torque load and actual torque demand on at least one of:
the prime mover coupled with the variable displacement hydrostatic pump; and
the hydrostatic pump and motor of the hydrostatic pump-motor assembly; and
change an amount of displacement associated with the hydrostatic pump on the basis of the determined current torque load and actual torque demand.
